(19) United States
(12) Patent Application Publication
(10) Pub. No.: US 2012/0016779 A1
(43) Pub. Date: Jan. 19, 2012

(54) SYSTEM AND METHOD FOR ASSISTING A CONTRACTOR TO EFFICIENTLY SERVICE AN EQUIPMENT

(76) Inventors: Kenneth Troy LANDRY, Sugar Land, TX (US); Rui WANG, Katy, TX (US); Terrance Michael SMITH, Houston, TX (US)

(21) Appl. No.: 12/835,159

(22) Filed: Jul. 13, 2010

(51) Int. Cl. G06Q 10/00

(52) U.S. Cl. 705/28; 705/302; 705/305

(57) ABSTRACT

A method and system are disclosed for assisting a contractor to efficiently service an equipment. The method and system enable contractors, such as heating, ventilation, and air conditioning (HVAC) contractors, dealers, and technicians, to improve efficiency in providing services to their customers. The method and system formalize the repair planning execution tasks, and provide data in useful formats immediately available at a work site to contractors, thus reducing avoidable errors and improving efficiency in repairing or replacing equipment.

### BACKGROUND

When planning to service or while servicing equipment, a contractor, such as a heating, ventilation, and air conditioning (HVAC) contractor or technician, consumes a significant amount of time to obtain information necessary to propose and effect a repair or a replacement rather than utilizing his technical skills. Specifically, the contractor must acquire some or all of equipment-related data after arriving at a work site and before beginning or during the diagnosis or repair activities.

This equipment-related data includes manufacturers' assembly parts lists and descriptions for models and versions of equipment; service parts for superseded items; applicable service bulletin numbers and descriptions; diagnostic procedures for the equipment; capacity charts for competitor's equipment for use in selecting appropriate replacement equipment; equipment catalog summaries of capacity and electrical power and space requirements; equipment sales promotion information; locations, telephone numbers and distances to close-by distributor sites; base and extended warranty coverage for the failing units; availability of repair or replacement parts and equipment at close-by distributor sites; ability to enter an order to reserve replacement parts and equipment for pick-up; links for access by telephone to qualified technical service representatives of the equipment's manufacturer; access to instant message services used by qualified technical service representatives of the manufacturers; links for access by e-mail to qualified technical service representatives of the manufacturers; and warranty repair history of the equipment.

However, this equipment-related data are typically not available at the work site, leading to avoidable errors and delays in repairing or replacing equipment.

### SUMMARY

An embodiment of a method assists a contractor to efficiently service an equipment. The method is implemented by a computing device including a processor and a memory. The method includes receiving a request for equipment information from a contractor servicing an equipment at a job site. The contractor requests the equipment information using the computing device. The method further includes accessing, through the computing device and using a network and a manufacturer web server, manufacturer application servers located in a private network. The equipment information is related to the equipment to be serviced and includes distributor data stored in a manufacturer database. The method further includes providing the requested equipment information to the contractor from one source using the network, locating a nearby distributor using the computing device, checking inventory of the nearby distributor using the computing device, reserving a part or replacement equipment using the computing device, and updating the distributor data related to the equipment in the manufacturer database using the network and a manufacturer database server.

An embodiment of a system assists a contractor to efficiently service an equipment. The system includes a computing device that receives a request for equipment information from a contractor servicing an equipment at a job site and transmits the request to a manufacturer system. The equipment information is related to the equipment to be serviced and includes distributor data stored in a manufacturer database or retrieved by the manufacturer's application server. The system further includes the manufacturer system that includes a manufacturer web server that accepts the request from the computing device, manufacturer application servers located in a private network, and a database server accessing the manufacturer database to obtain the equipment information. The computing device accesses, using a network, the manufacturer web server and the manufacturer application servers to obtain the requested equipment information from one source, locates a nearby distributor, checks inventory, and reserves a part or replacement equipment. The distributor data related to the equipment is updated in the manufacturer database using the network and a manufacturer database server.

An embodiment of a computer readable medium provides instructions for assisting a contractor to efficiently service an equipment. The instructions include receiving a request for equipment information from a contractor servicing an equipment at a job site. The contractor requests the equipment information using a computing device. The instructions further include accessing, through the computing device and using a network and a manufacturer web server, manufacturer application servers located in a private network. The equipment information is related to the equipment to be serviced and includes distributor data stored in a manufacturer database. The instructions further include providing the requested equipment information from one source to the contractor using the network, locating a nearby distributor using the computing device, checking inventory of the nearby distributor using the computing device, reserving a part or replacement equipment using the computing device, and updating the distributor data related to the equipment in the manufacturer database using the network and a manufacturer database server.

### DESCRIPTION OF THE DRAWINGS

The detailed description will refer to the following drawings, wherein like numerals refer to like elements, and wherein:

FIG. 1 illustrates an embodiment of a system for assisting a contractor to efficiently service an equipment;

FIG. 2 is a flow chart illustrating an embodiment of a method for assisting a contractor to efficiently service an equipment;

FIGS. 3-11 illustrate exemplary website pages generated by the system 100 for providing a system for assisting a contractor to efficiently service an equipment; and

FIG. 12 illustrates exemplary hardware components of a computer that may be used in connection with the method for assisting a contractor to efficiently service an equipment.

### DETAILED DESCRIPTION

Embodiments of a method and system enable contractors, such as heating, ventilation, and air conditioning (HVAC) contractors, dealers, and technicians (collectively referred to as contractors) to improve efficiency in providing services to their customers. Embodiments of the method and system provide information primarily for the use of contractors who are servicing or selling equipment made by a particular manufacturer (i.e., company), such as Goodman Global, Inc. (GGI). Embodiments of the method and system further benefit independent distributors and company operated distribution centers selling equipment and repair parts.

Embodiments of the method and system formalize the repair planning and execution tasks, and provide data in useful formats immediately available at a work site to contractors, thus reducing avoidable errors and improving efficiency in repairing or replacing equipment. Specifically, embodiments of the method and system provide a seamless integration of various applications to provide useful equipment information from one source.

The system may include or utilize a remote computing device, such as a hand-held device capable of browsing the web. The hand-held device may be utilized by a contractor and may be a cellular telephone, a Blackberry® device, a smartphone device, an iPhone® device or mobile equipment providing similar data oriented functions. A cellular telephone may have limited functions because of fewer screen graphic capabilities available and the small screen. A Blackberry® device includes a standard browser without the need for add-in software. A smartphone device may host operating systems that support standard web browser capabilities. An iPhone® device may use standard web browser capabilities without the need for add-in software.

The system may further include a web access from the mobile telephony and fixed location or portable personal computer (PC) equipment. The web access may be contractor-paid. The system may further include a web connection to computing systems and databases.

The contractor may determine warranty coverage of units at an address by searching warranty databases using partial homeowner name and zip code. Alternatively, the contractor may inquire by model and serial number after reading those from the subject unit.

In the event of a repair call, the contractor may discuss the symptoms with the homeowner and determine whether the homeowner bought the equipment directly or as part of a new or pre-existing home purchase. The contractor may perform a visual and electrical power inspection and obtain the model and serial numbers. Using the hand-held device, the contractor may check for applicable service bulletins that may aid in diagnosing or repairing the problem. The bulletins may be obtained from a service truck, by calling the contractor's own office, or from the manufacturer's technical service line. The contractor may check the warranty repair history of the equipment to determine other failures and repairs performed on the equipment. The contractor may then perform diagnostic tests and obtain diagnostic procedures using the hand-held device. The diagnostic procedure may be retrieved from the service truck or by calling the contractor's own office or the manufacturer's technical service line. If needed, the contractor may use an instant messaging service to contract the manufacturer's technical service line personnel for solutions to conditions not described in the diagnostic procedure. Further, the contractor may use an e-mail link to forward information requested by the technical service line personnel, including pictures. The contractor may check warranty coverage using the hand-held device to assess whether to recommend equipment repair or replacement to homeowner. If the contractor recommends repair, the contractor may determine repair parts necessary to restore the equipment to service. The contractor may use the hand-held device to obtain the exploded parts list and the service parts list. The contractor may further use the hand-held device to determine availability of repair parts from distribution centers located close-by the work site. Alternatively, the contractor may use a distributor locator function of the system to determine a closest distribution location of its preferred independent distributor or company operated distribution site. The contractor may determine the approximate cost of repair and present to the homeowner for approval. Upon approval, the contractor may reserve the repair parts using the hand-held device.

In the event of a replacement call, the contractor may listen to the homeowner's performance and cost requirements, inspect the installed equipment, select equipment to recommend, prepare the bid and gather the marketing and descriptive materials. The contractor may use a capacity chart lookup function of the system to determine the capacity of the replacement equipment. The contractor may use an equipment catalog summary function of the system to ensure the proposed installation site provides adequate power and space. The contractor may then check for promotions and deals using the summary information of the system relevant to the equipment the contractor proposes.

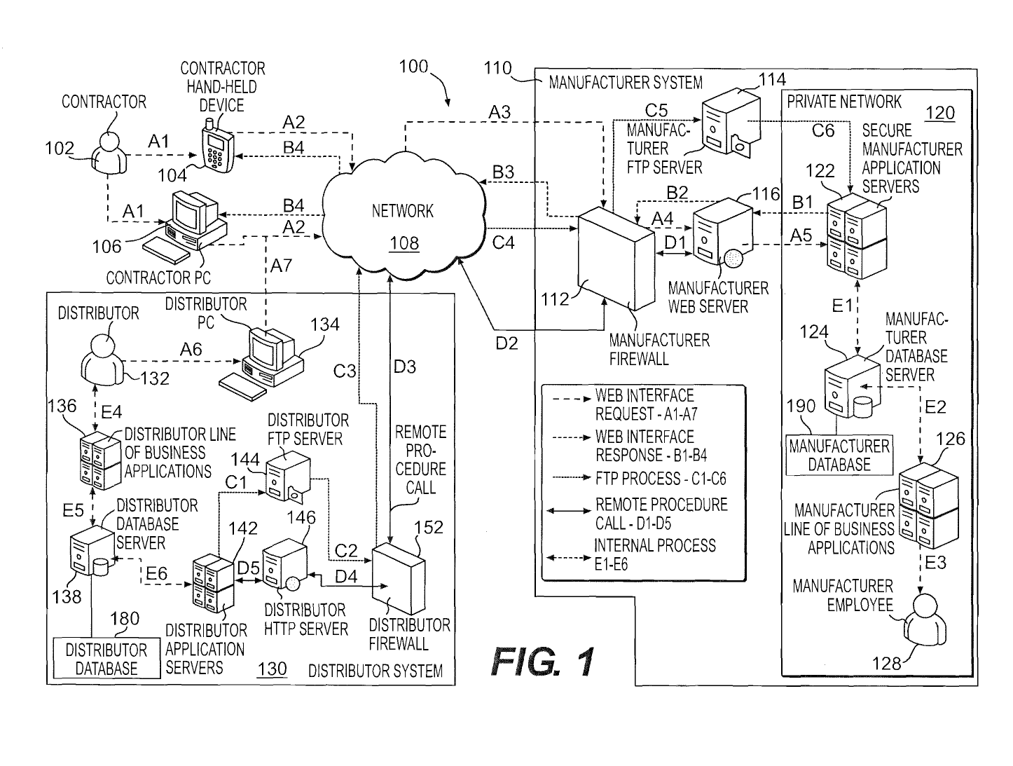

FIG. 1 illustrates an embodiment of a system 100 for assisting a contractor to efficiently service an equipment. After arriving at a job site, a contractor 102, i.e., dealer or technician, may conduct an initial problem assessment and may obtain serial numbers and other information relevant to the equipment to be repaired or replaced. The contractor 102 may access the system 100 to obtain information related to the equipment, i.e., equipment information. The contractor 102 may access the system 100 using two methods. The contractor 102 may use a computing device such as a hand-held device 104 (line A1) that hosts, for example, an Internet browser and has a wireless Internet connection. Examples include a smartphone device, a Blackberry® device, an iPhone® device, and PC equipment operating wireless connections based on international mobile technology standards. Alternatively, the contractor 102 may use a wired or wireless PC 106 (line A1) hosting, for example, an Internet browser and connected to the Internet using a local area network that provides a gateway through wireless local or wide area network technologies, a Wi-Fi connection or other Internet connections.

The contractor's request for equipment information may be transmitted from the contractor PC 106 or the contractor hand-held device 104 to a network 108 (line A2), such as wireless application protocol (WAP), Internet, or the like, and then to a manufacturer system 110. Specifically, the request for equipment information may be transmitted, e.g., through a manufacturer firewall 112 (line A3), to a manufacturer web server 116 (line A4). Based on the request parameters, the manufacturer web server 116 may send the request for equipment information to secure manufacturer application servers 122 in a manufacturer private network 120 (line A5). The secure manufacturer application servers 122 may access a manufacturer database server 124 (line E1) to obtain the equipment information saved in a manufacturer database 190.

Alternatively, the manufacturer web server 116 may send the request for equipment information to a distributor system 130 using a remote procedure call (RPC) (lines D1, D2, D3, D4, D5). The equipment information requested may include distributor data, such as distribution locations and inventory balances. A distributor's personnel typically create and maintain distributor RPC programs. The RPC message may be sent through a distributor firewall 152 (line D3). The manufacturer web server 116 may send a message that causes the distributor RPC programs to execute on a distributor hypertext transfer protocol (HTTP) server 146 (line D4). The message may contain RPC predefined parameters. The distributor HTTP server 146 receives the message containing RPC predefined parameters, and sends the request for equipment information to the distributor application servers 142 (line D5). The distributor application servers 142 may access a distributor database server 138 (line E6) to obtain the requested equipment information, which includes the distributor data. The distributor data is typically stored in a distributor database 180. The distributor application servers 142 may send the results as a response to the manufacturer web server 116 (lines D5, D4, D3, D2, D1). The distributor data stored in the distributor database 180 may be updated internally by a distributor 132 (line E4) using distributor line of business applications 136, which process business activities of the distributor and update the distributor database server 138 (line E5).

The manufacturer web server 116 may receive response messages, including equipment information, from the secure manufacturer application servers 122 (line B1) or from the distributor system 130 through the RPC (lines D1, D2, D3, D4, D5). The response messages may be sent through the manufacturer firewall 112 (line B2), the network 108 (line B3) to the contractor PC 106 (line B4) or the contractor hand-held device 104 (line B4).

The distributor 132 may asynchronously use a distributor PC 134 (line A6) to send a message to the manufacturer system 110 to update the distributor data in the manufacturer database 190. The database update message may be sent to the network 108 (line A7) and then through the manufacturer firewall 112 (line A3) to the manufacturer web server 116 (line A4). The manufacturer web server 116 may transmit the database update message to the secure manufacturer application servers 122 (line A5). The secure manufacturer application servers 122 may use the manufacturer database server 124 (line E1), computer programs, such as manufacturer line of business applications 126 (line E2), and a manufacturer employee 128 (line E3) to review and update the distributor data, which is stored in the manufacturer database 190.

The system 100 may alternatively use a file transfer protocol (FTP) process (lines C1, C2, C3, C4, C5, C6) to transfer the distributor data to the manufacturer database 190 to make the distributor data available to the contractor 102. Specifically, the distributor data may be generated and updated by the distributor line of business applications 136, and then stored in the distributor database 180. The distributor application servers 142 may access the distributor database server 138 to obtain the updated distributor data, and send the updated distributor data to a distributor FTP server 144 (line C1). The updated distributor data may be sent through the distributor firewall 152 (line C2) to the network 108 (line C3) and then through the manufacturer firewall 112 (line C4) to the manufacturer FTP server 114 (line C5). The manufacturer FTP server 114 may send the updated distributor data to the secure manufacturer application servers 122 (line C6). The secure manufacturer application servers 122 may read and store the updated distributor data in the manufacturer database 190 to be accessed by the contractor 102.

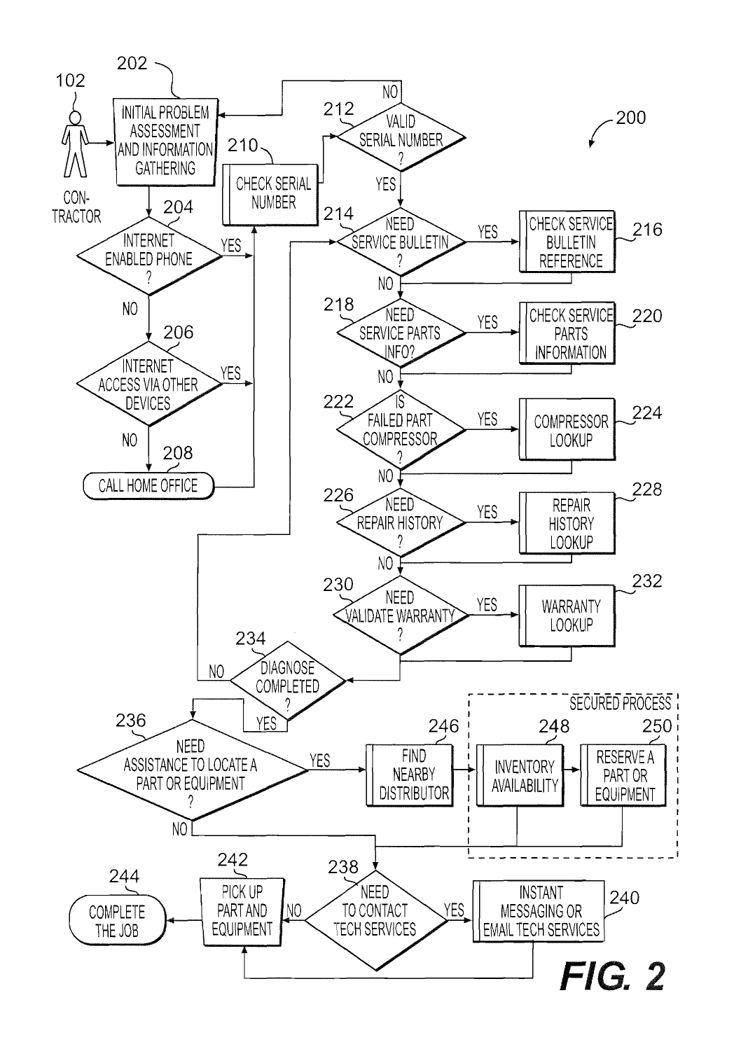

FIG. 2 is a flow chart illustrating an embodiment of a method 200 for assisting a contractor to efficiently service an equipment. After arriving at a job site, the contractor 102 performs an initial problem assessment and information gathering, such as gathering the serial number of the equipment to be serviced (block 202). If the contractor 102 has an Internet enabled hand-held device (block 204) or other devices that can access the Internet (block 206), the contractor 102 may check the serial number of the equipment using the Internet access and the system 100 (block 210). If the contractor 102 does not have an Internet enabled device, the contractor may call the home office (block 208) so that someone in the office can (e.g., using a PC) check the serial number of the equipment to be serviced.

If the serial number is valid (block 212), the method 200 may determine if a service bulletin is needed (block 214) and, if yes, may check service bulletin references (block 216) using the Internet enabled hand-held device or by calling the home office. If service parts information is needed (block 218), the method 200 may check service parts information stored in the manufacturer database 190 (block 220) using the Internet enabled device (block 204 or block 206) or by calling the home office (block 208). If the failed part is a compressor (block 222), for example, the method 200 may lookup compressor information stored in the manufacturer database 190 (block 224) using the Internet enabled device or by calling the home office. If repair history is needed (block 226), the method 200 may lookup the repair history stored in the manufacturer database 190 (block 228) using the Internet enabled device or by calling the home office. If the contractor wishes to validate warranty coverage (block 230), the method 200 may look up warranty information stored in the manufacturer database 190 (block 232) using the Internet enabled device or by calling the home office.

If the diagnosis is not completed, the method 200 returns to block 214 and may perform additional steps as described herein. If the diagnosis is complete (block 234), the method 200 determines if assistance is needed to locate a part or replacement equipment (block 236). If assistance is needed, the method 200 may find a nearby distributor using the distributor data stored in the manufacturer database 190 (block 246). The method 200 may determine the inventory availability using the distributor data stored in the manufacturer database 190 or in the distributor database 180 (block 248) and may reserve the part or the replacement equipment using the system 100 (block 250).

Whether or not the part or replacement equipment has been reserved, the method 200 determines if there is a need to contact manufacturer technical services (block 238). If yes, the method 200 enables the contractor 102 to instant message or e-mail the technical services (block 240). If not, the contractor 102 picks up the part or replacement equipment (block 242) to complete the job (block 244).

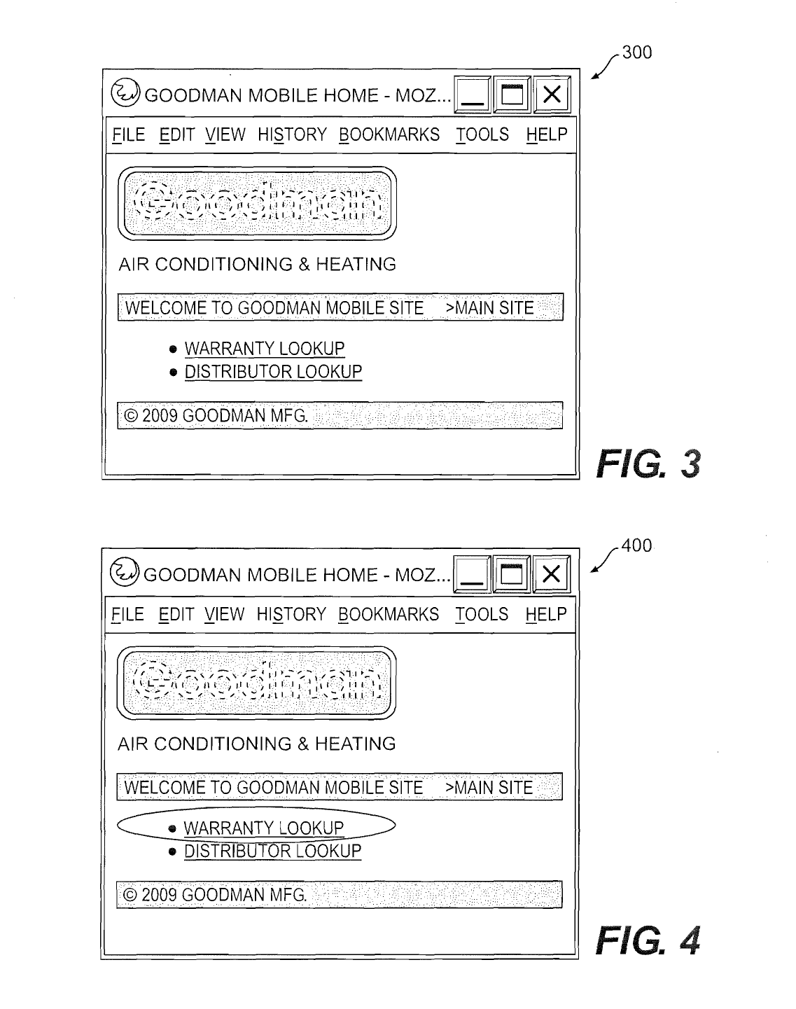

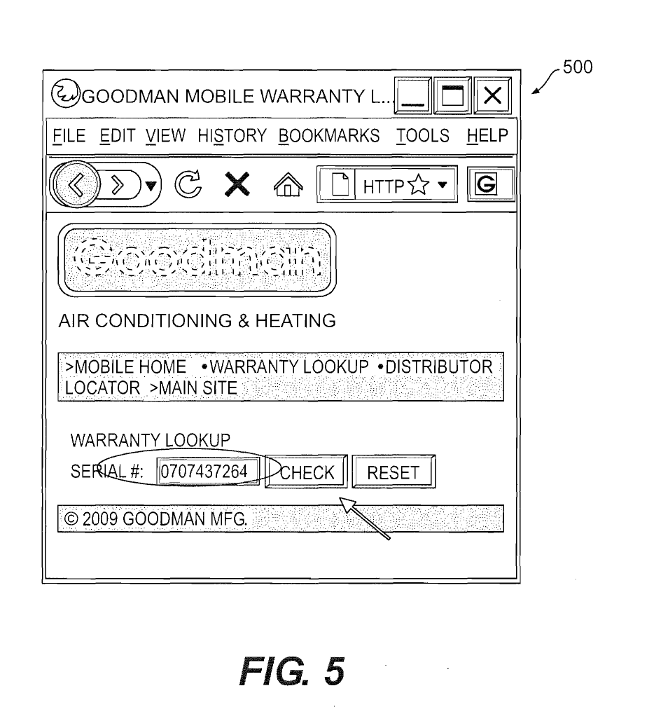

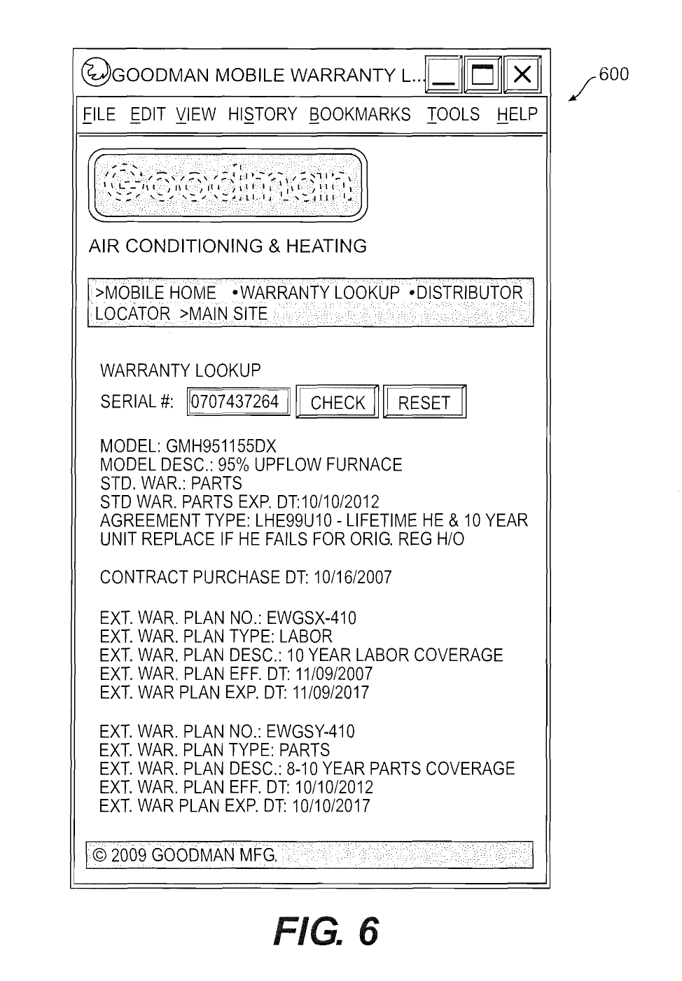

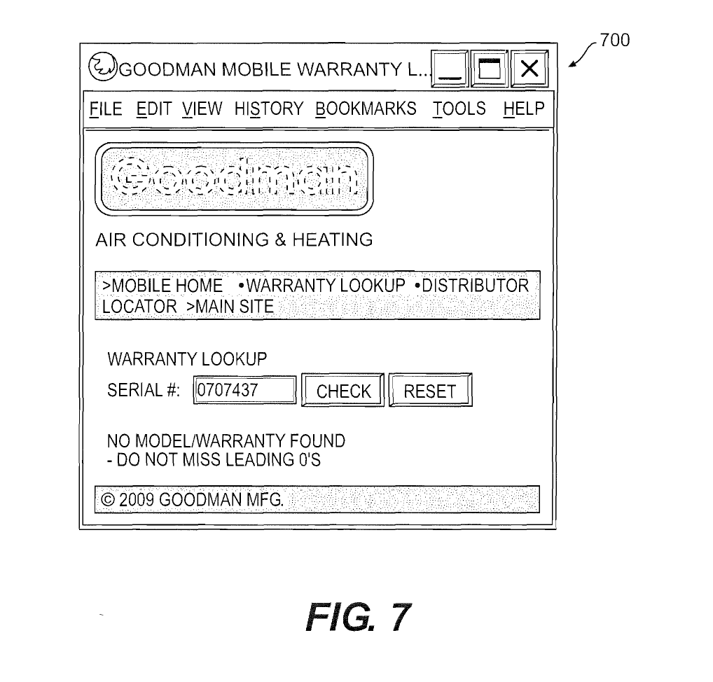

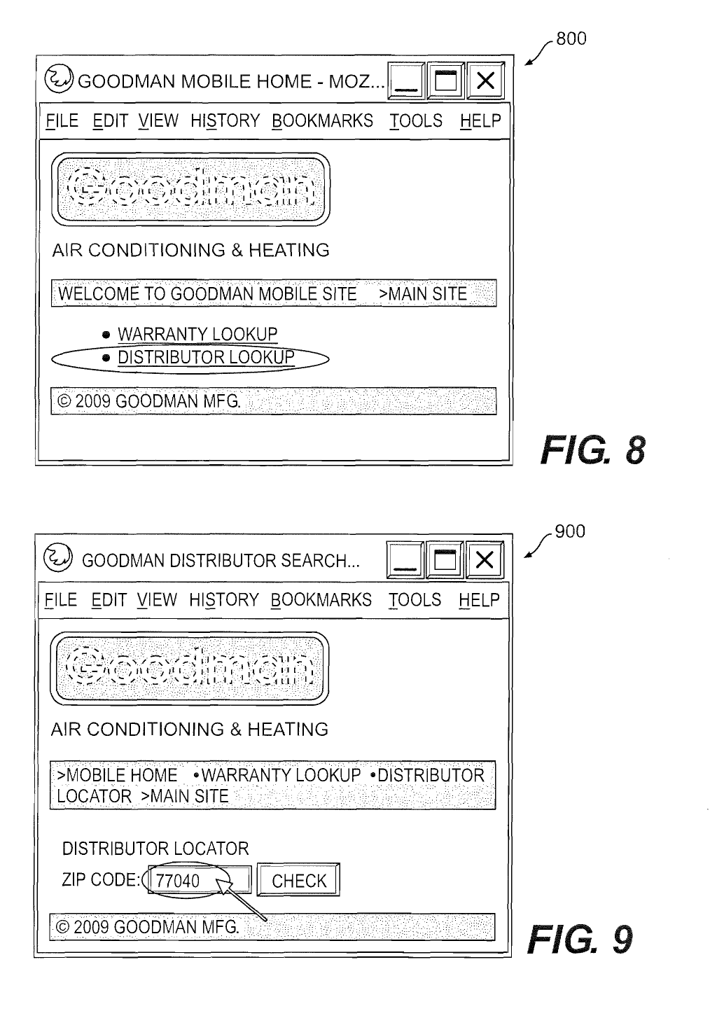

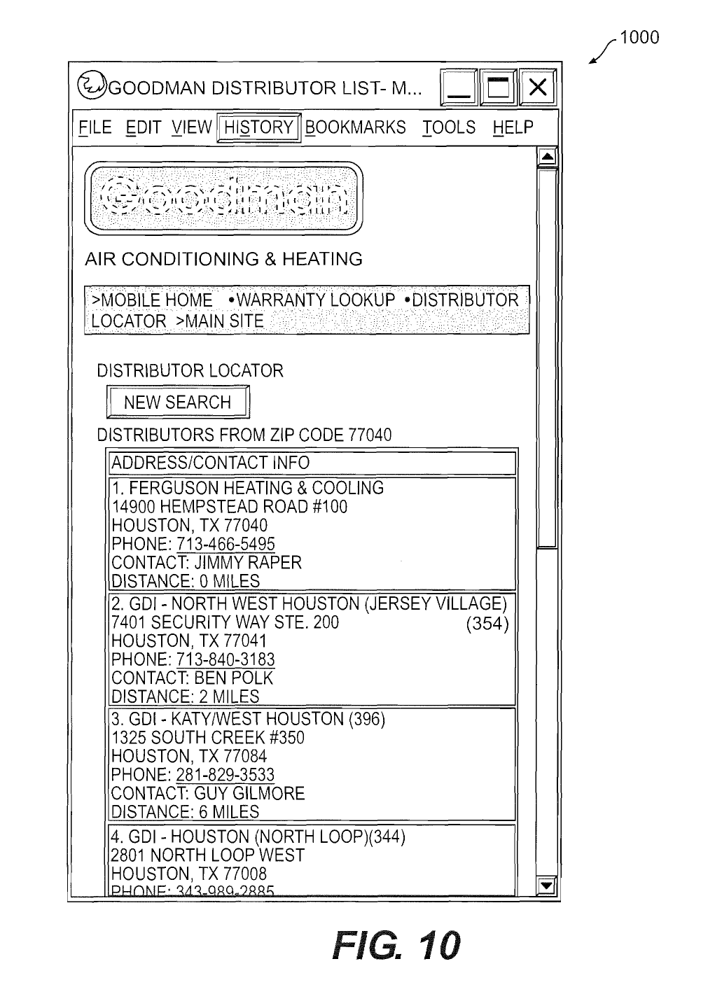

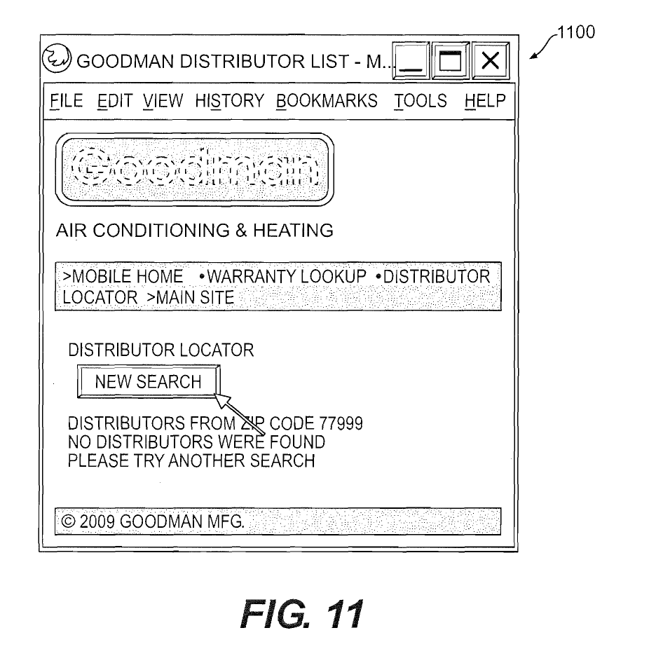

FIGS. 3-11 illustrate exemplary website pages generated by the system 100 for assisting a contractor to efficiently service an equipment. FIG. 3 illustrates an exemplary main page 300. A contractor can select, for example, “Warranty Lookup” or “Distributor Locator.” FIG. 4 illustrates an exemplary warranty main page 400 when the “Warranty Lookup” option is selected. FIG. 5 illustrates an exemplary warranty lookup page 500 that enables the contractor to enter a serial number of equipment. FIG. 6 illustrates an exemplary warranty information page 600 that displays available warranty information. FIG. 7 illustrates an exemplary warranty error message page 700 that displays an error message if the serial number is invalid or the warranty information is unavailable. FIG. 8 illustrates an exemplary main page 800 when the “Distributor Locator” option is selected. FIG. 9 illustrates an exemplary distributor locator page 900 that enables the contractor to enter a zip code. FIG. 10 illustrates an exemplary distributor information page 1000 that displays a list of available distributors. Results may be listed by which distributor location is closest to furthest. FIG. 11 illustrates an exemplary distributor error message page 1100 that displays an error message if the contractor inputs an invalid zip code. The contractor may click a “New Search” button to start another search or click a “Mobile Home” button to return to the main page.

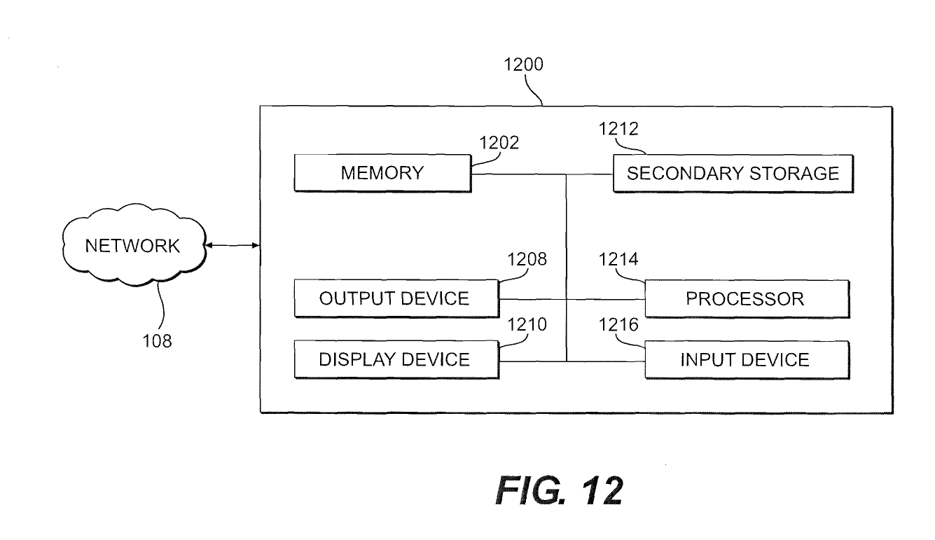

FIG. 12 illustrates exemplary hardware components of a computer or computing device 1200 that may be used in connection with the method 200 for assisting a contractor to efficiently service an equipment. The computer 1200 may be the PC 106, 134, the hand-held device 104, or the servers, and may include a connection with the network 108, such as the Internet or other type of computer network. The computer 1200 typically includes a memory 1202, a secondary storage device 1212, a processor 1214, an input device 1216, a display device 1210, and an output device 1208.

The memory 1202 may include random access memory (RAM) or similar types of memory. The secondary storage device 1212 may include a hard disk drive, floppy disk drive, CD-ROM drive, or other types of non-volatile data storage, and may correspond with various databases or other resources, such as the manufacturer database 190 and the distributor database 180. The processor 1214 may execute programs using data stored in the memory 1202, the secondary storage 1212, or received from the Internet or other network 108, to perform methods and functions described herein. The input device 1216 may include any device for entering data into the computer 1200, such as a keyboard, keypad, cursor-control device, touch-screen (possibly with a stylus), or microphone. The display device 1210 may include any type of device for presenting a visual image, such as, for example, a computer monitor, flat-screen display, or display panel. The output device 1208 may include any type of device for presenting data in hard copy format, such as a printer, or other types of output devices including speakers or any device for providing data in audio form. The computer 1200 can possibly include multiple input devices, output devices, and display devices.

Although the computer 1200 is shown with various components, one skilled in the art will appreciate that the computer 1200 can contain additional or different components. In addition, although aspects of an implementation consistent with the method for assisting a contractor to efficiently service an equipment are described as being stored in memory, one skilled in the art will appreciate that these aspects can also be stored on or read from other types of computer program products or computer-readable media, such as secondary storage devices, including hard disks, floppy disks, or CD-ROM; or other forms of RAM or ROM. The computer-readable media may include instructions for controlling the computer 1200 to perform a particular method, such as methods described herein.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

What is claimed is:

1. A method for assisting a contractor to efficiently service an equipment, the method being implemented by a computing device including a processor and a memory, the method comprising:
receiving a request for equipment information from a contractor servicing an equipment at a job site, wherein the contractor requests the equipment information using the computing device;
accessing, through the computing device and using a network and a manufacturer web server, manufacturer application servers located in a private network, wherein the equipment information is related to the equipment to be serviced and includes distributor data stored in a manufacturer database;
providing the requested equipment information to the contractor from one source using the network;
locating a nearby distributor using the computing device;
checking inventory of the nearby distributor using the computing device;
reserving a part or replacement equipment using the computing device; and
updating the distributor data related to the equipment in the manufacturer database using the network and a manufacturer database server.

2. The method of claim 1, wherein the computing device is a hand-held device hosting an Internet browser.

3. The method of claim 1, wherein the computing device is a personal computer hosting an Internet browser.

4. The method of claim 1, wherein the distributor data includes distribution locations and inventory balances.

5. The method of claim 1, further comprising determining if a serial number of the equipment is valid using the equipment information.

6. The method of claim 1, further comprising determining if the equipment is under a valid warranty using the equipment information.

7. The method of claim 1, further comprising checking a service bulletin reference related to the equipment using the network and the computing device.

8. The method of claim 1, further comprising checking a repair history related to the equipment using the network and the computing device.

9. The method of claim 1, further comprising enabling the contractor to instant message or e-mail technical services regarding the equipment using the network and the computing device.

10. The method of claim 1, further comprising using a file transfer protocol (FTP) process to transfer the distributor data from a distributor system to the manufacturer database.

11. The method of claim 1, further comprising:
sending a message to a distributor system requesting the distributor data;
causing a remote procedure call (RPC) program to execute on a distributor hypertext transfer protocol (HTTP) server;
sending an RPC predefined parameters to the distributor HTTP server;
reading the requested distributor data from a distributor database; and
sending the requested distributor data to the manufacturer web server.

12. A system for assisting a contractor to efficiently service an equipment, comprising:
a computing device that receives a request for equipment information from a contractor servicing an equipment at a job site and transmits the request to a manufacturer system, wherein the equipment information is related to the equipment to be serviced and includes distributor data stored in a manufacturer database; and
the manufacturer system, comprising:
a manufacturer web server that accepts the request from the computing device;
manufacturer application servers located in a private network; and
a database server accessing the manufacturer database to obtain the equipment information;
wherein the computing device accesses, using a network, the manufacturer web server and the manufacturer application servers to obtain the requested equipment information from one source, locates a nearby distributor, checks inventory, and reserves a part or replacement equipment, and wherein the distributor data related to the equipment is updated in the manufacturer database using the network and a manufacturer database server.

13. The system of claim 12, wherein the computing device is a hand-held device hosting an Internet browser.

14. The system of claim 12, wherein the computing device is a personal computer hosting an Internet browser.

15. The system of claim 12, wherein the distributor data includes distribution locations and inventory balances.

16. The system of claim 12, wherein the manufacturer system determines if a serial number of the equipment is valid using the equipment information.

17. The system of claim 12, wherein the manufacturer system determines if the equipment is under a valid warranty using the equipment information.

18. The system of claim 12, wherein the computing device send instant messages or e-mails to technical services regarding the equipment using the network.

19. The system of claim 12, further comprising a file transfer protocol (FTP) process that transfers the distributor data from a distributor system to the manufacturer database.

20. The system of claim 12, wherein the manufacturer system sends a message to a distributor system requesting the distributor data, causes a remote procedure call (RPC) program to execute on a distributor hypertext transfer protocol (HTTP) server, sends an RPC predefined parameters to the distributor HTTP server, and receives the requested distributor data that is stored in a distributor database using the manufacturer web server.

21. A computer readable medium providing instructions for assisting a contractor to efficiently service an equipment, the instructions comprising:
receiving a request for equipment information from a contractor servicing an equipment at a job site, wherein the contractor requests the equipment information using a computing device;
accessing, through the computing device and using a network and a manufacturer web server, manufacturer application servers located in a private network, wherein the equipment information is related to the equipment to be serviced and includes distributor data stored in a manufacturer database;
providing the requested equipment information from one source to the contractor using the network;
locating a nearby distributor using the computing device;
checking inventory of the nearby distributor using the computing device;
reserving a part or replacement equipment using the computing device; and
updating the distributor data related to the equipment in the manufacturer database using the network and a manufacturer database server.
